(19) United States
(12) Patent Application Publication
(10) Pub. No.: US 2004/0049327 A1
(43) Pub. Date: Mar. 11, 2004

(54) Radio based automatic train control system using universal code

(76) Inventors: Robert Allen Kondratenko, Jeffersonton, VA (US); Kevin W. Klopp, Warrenton, VA (US); William Bernard Dufer, Pittsburgh, PA (US)

Correspondence Address: Richard Sawatzki, Patent Attorney, 1001 26th St. NW #504, Washington, DC, 20037, US

(21) Appl. No.: 10/656,036

(22) Filed: Sep. 5, 2003

Related U.S. Application Data
(60) Provisional application No. 60/409,697, filed on Sep. 10, 2002.

(51) Int. Cl. G06F 17/00

(52) U.S. Cl. 701/19; 246/167 R

(57) ABSTRACT

A vital radio based automatic train control system that will interface seamlessly with existing onboard ATC equipment via existing track receiver inputs or directly. The invention provides a means of extending ATC signal territory with reduced equipment installation as compared to traditional cab or wayside based ATC. The invention can be used to reduce train braking distances and reduce headway. Furthermore, the radio cab signal can be used for additional purposes including but not limited to wayside equipment monitoring and rolling equipment monitoring.

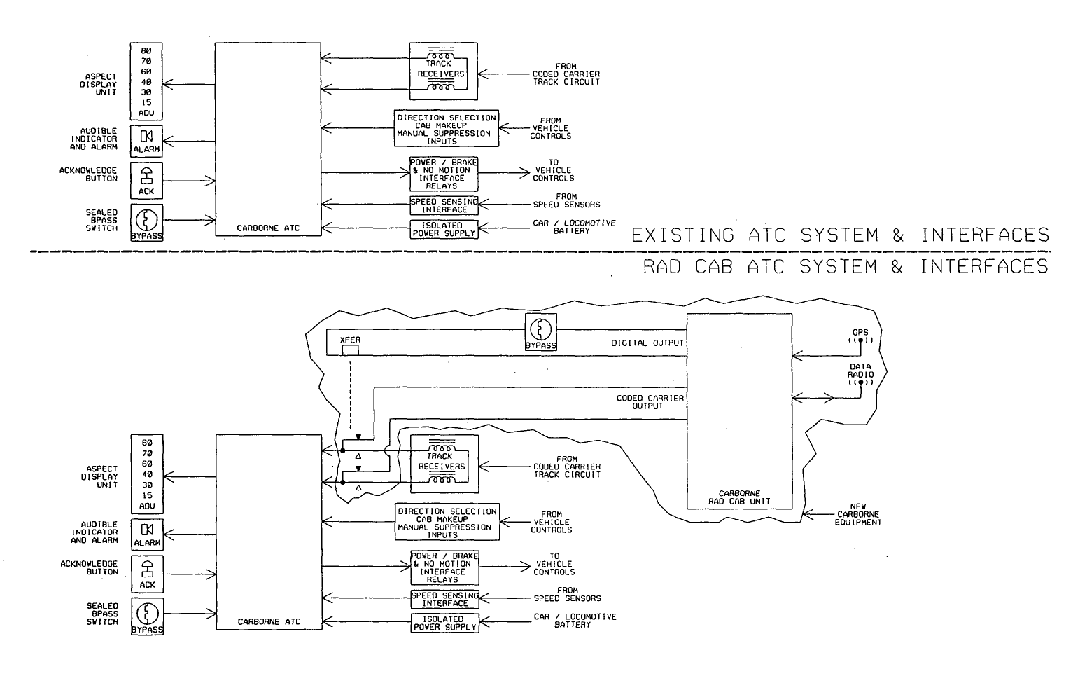

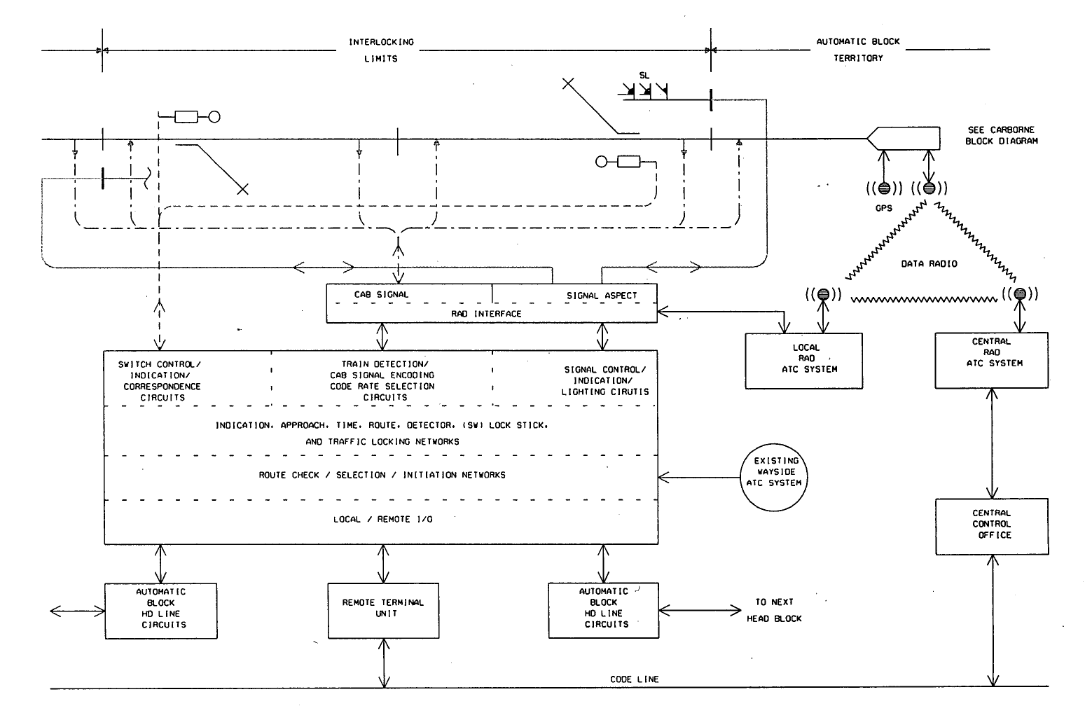

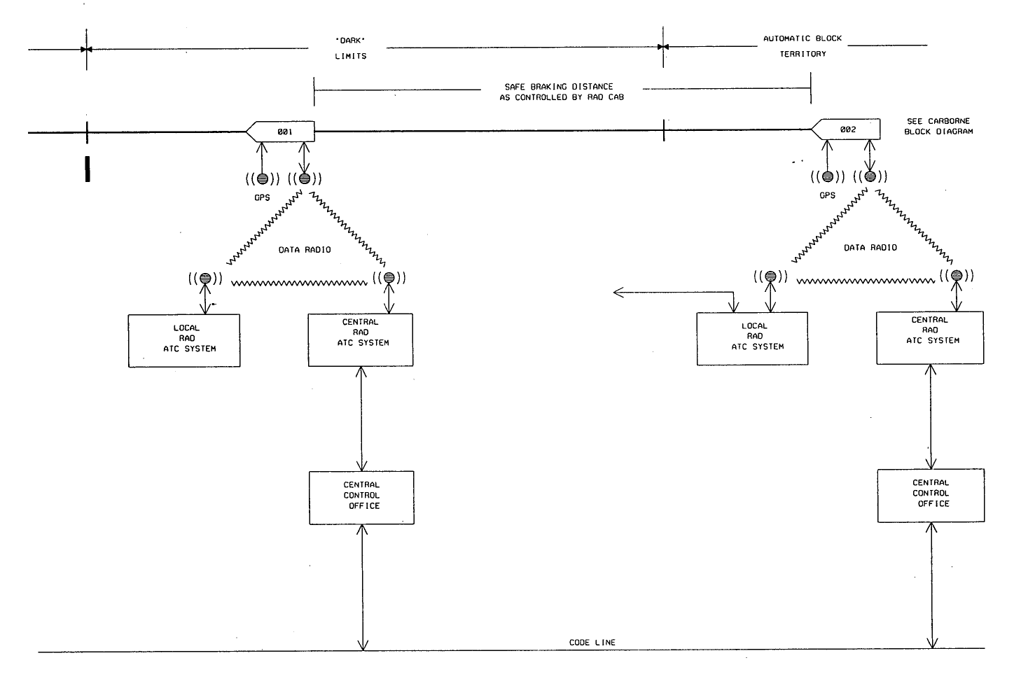

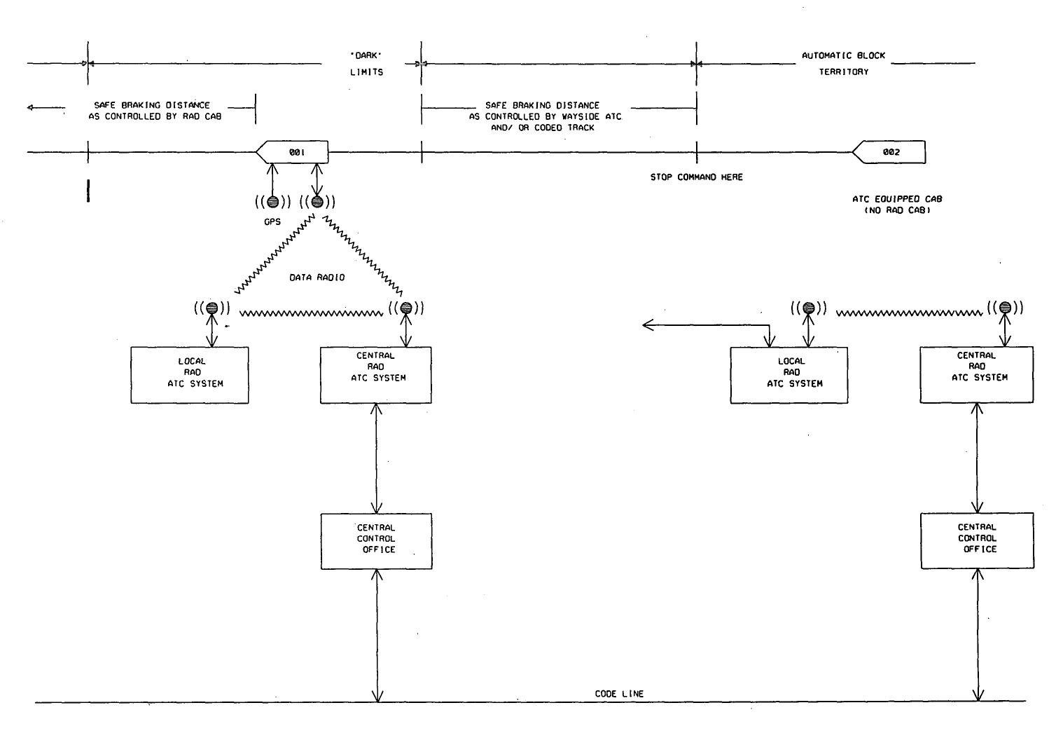

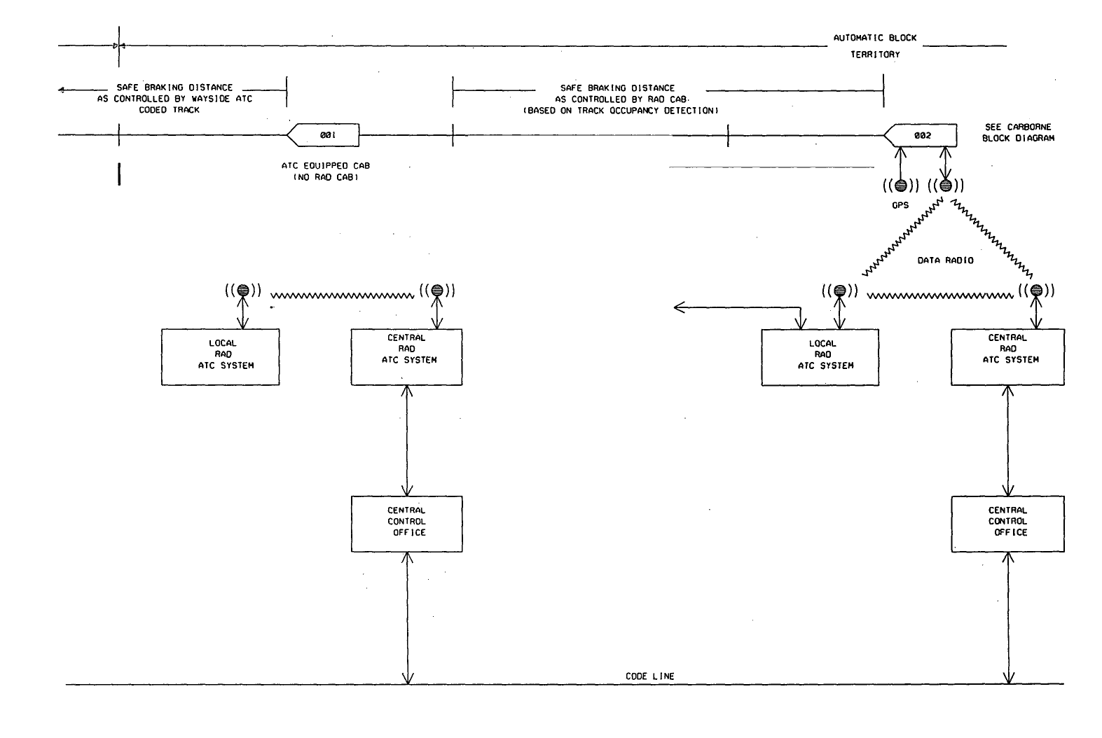

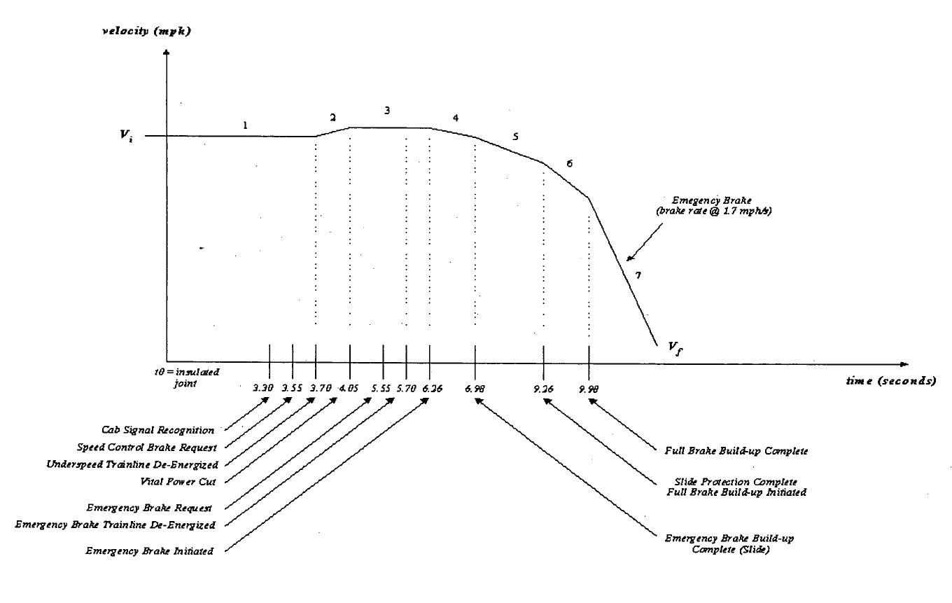

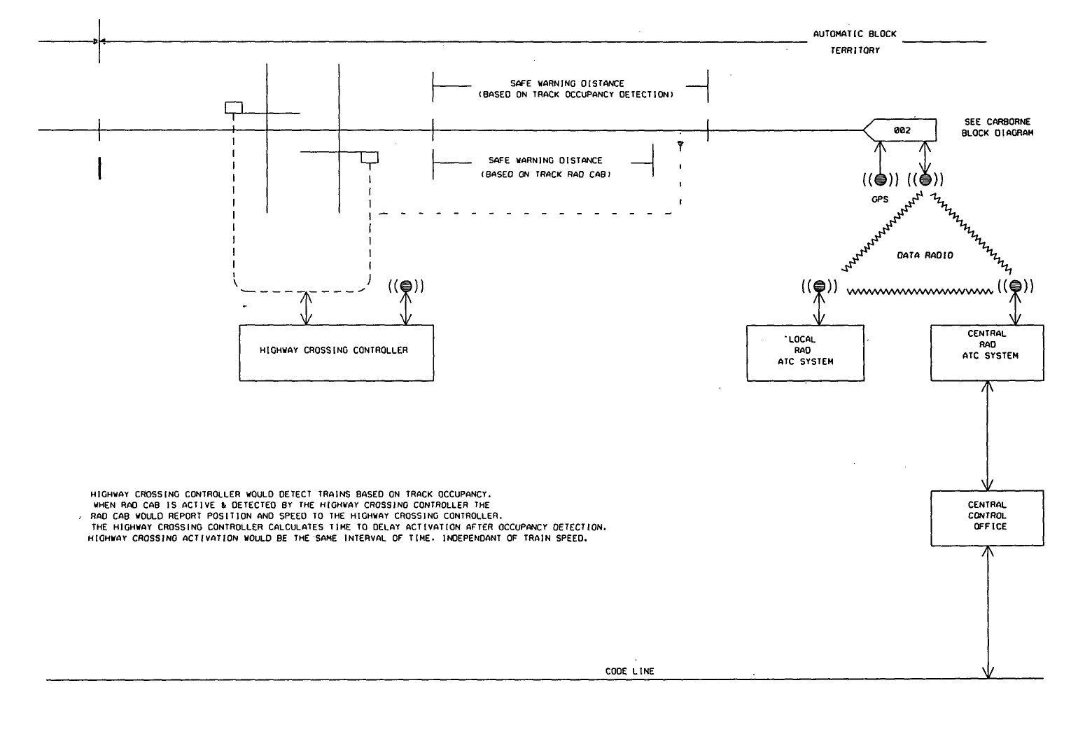

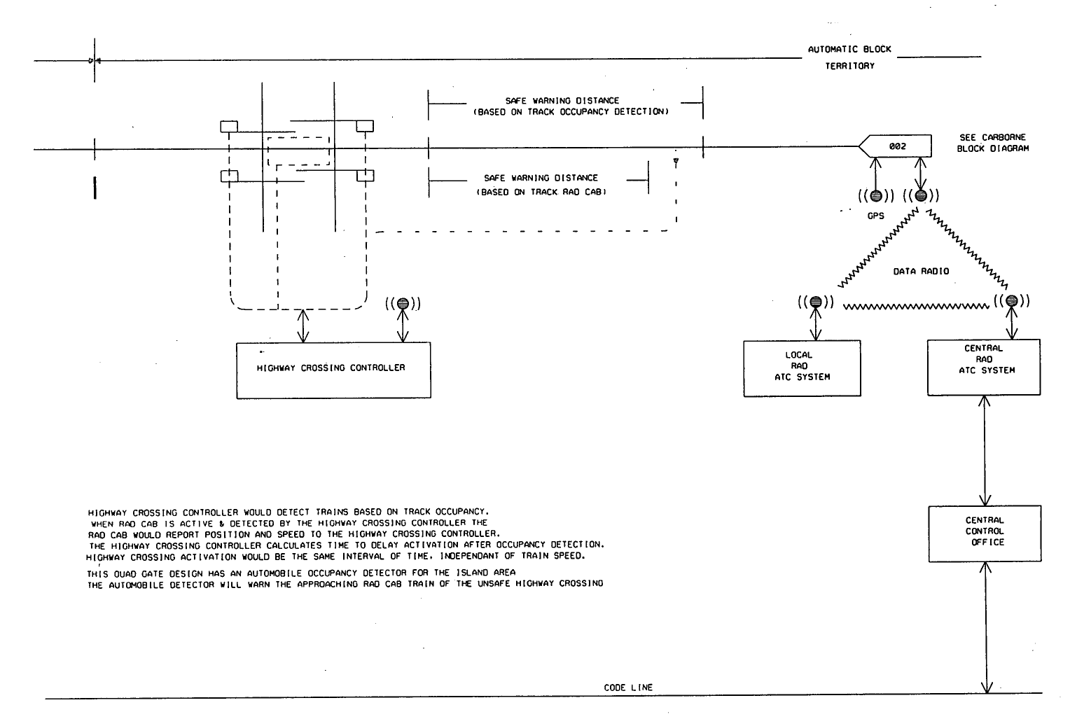

### CROSS-REFERENCE TO RELATED APPLICATIONS

This application is entitled to the benefit of Provisional Patent Application Ser. No. 60/409,697 filed Sep. 10, 2002.

### STATEMENT REGARDING FEDERALLY SPONSERED RESEARCH OR DEVELOPEMENT

Not Applicable

### REFERENCE TO SEQUENCE LISTING, A TABLE, OR A COMPUTER PROGRAM LISTING COMPACT DISK APPENDIX

Not Applicable

### BACKGROUND

1. Field of Invention

This invention relates to the field of Automatic Train Control for use on mainline, commuter and transit rail lines.

2. Description of Prior Art

Automatic Train Control (ATC) is the system for automatically controlling train movement, enforcing train safety, and directing train operations. Typically railway signal control systems use a track circuit block as the basic element of train location, communications and control. Electrical signals applied to the length of track comprising a block is shunted by the rail vehicles axle and the change in signal is detected and used to indicate a track block that is occupied. Track circuits can be used to establish communication for wayside equipment to moving rail vehicles. These communications can be used to signal the engineer operating the train of various conditions for example, speed restrictions. These communications are called CAB Signaling. Train control equipment that is located on the train is called carborne. Train control equipment that is located along, or on the railroad track is called wayside equipment.

The track circuit system has a number of limitations. The accuracy of being able to locate the train is limited to the length of the track circuit. The cost of wayside equipment can be expensive. The cost of carborne equipment is both expensive and the size of the equipment can be a space problem. Additionally, the track circuits made by different companies are not generally compatible. If a locomotive moves from a rail line utilizing one companies wayside equipment to a track area with wayside equipment developed by another company the train would need carborne equipment from both companies, doubling the required equipment control space.

A more recent development is Communication Based Train Control (CBTC). Communications Based Train Control is a method of automatic train control in which the communication between the train and wayside is not done through the running rails. This technology typically involves spread spectrum radio and/or leaky coaxial cable along with inductive transponders for passing information and providing train position information.

The Global Positioning Satellite (GPS) system is used as a basis of train control in recent patents such as: “Methods and apparatus for locomotive tracking”, Doner, et al. U.S. Pat. No. 6,456,937 (2002); “Rail vehicle positioning system”, Burns, et al. U.S. Pat. No. 5,129,605 (1992); and “Method and system for automatically activating a warning device on a train”, Kane, et al. U.S. Pat. No. 6,609,049 (2003).

Each of the aforementioned systems and variations thereof has its advantages and disadvantages, which are not the issue here. All of the above systems are generally proprietary and non-interoperable. There are large costs to having two or more carborne systems. There are large costs to retrain the engineers who operate the trains. There is a greater risk of human error leading to catastrophe when transiting from one system to the next.

### SUMMARY

The present invention provides a vital radio based automatic train control system that will interface seamlessly with existing onboard ATC equipment via existing track receiver inputs or directly. The invention also provides a means of extending ATC signal territory with reduced equipment installations as compared to traditional cab or wayside based ATC. Furthermore, the radio cab signal can be used for additional purposes including but not limited to wayside equipment monitoring and rolling equipment monitoring.

### OBJECTIVES AND ADVANTAGES

The Radio Base Automatic Train Control System using Universal Code (RAD CAB) is not a replacement for an existing wayside/CAB ATC system. RAD CAB may be used as an upgrade to a present ATC system during implementation of a new ATC system, i.e. Communications Based Train Control (CBTC). Current ATC systems rely on industry standard rail transmitted cab signals. This invention interfaces directly to the existing carborne cab signal subsystem. The interface is accomplished by injecting a unique coded carrier signal past the track receivers defining the relative speed limits originating from radio transmission and not the track. The design is novel in that the new radio based system utilizes the existing carborne and wayside equipment. This permits the use of either system during transitioning from one system to the other or using one system as a fall back or redundant system for the other.

The proposed RAD CAB ATC System is a simple and efficient mean of converting any existing wayside signal, cab signal, and/or train control system to a new and modern CBTC System. The proposed RAD CAB ATC system can be based on a digital radio link and a GPS system. The RAD CAB ATC system can also be used to easily and economically extend ATC signaling into areas that presently have no or limited signaling.

A unique feature of this system is based on retaining the existing cab signal speed command and/or the existing wayside signal aspects. This permits complete utilization of existing equipment and related interfaces. A typical carborne ATC conversion is shown in the drawings.

The RAD CAB unit couples the new digital radio and GPS control data directly in the existing cab signal sub-system via a coded carrier oscillator signal defining the relative speed limits. A fail-safe transfer feature is provided between the existing and new equipment to simplify transition from the old to the new operating system. By retaining the existing CAB signal sub-system, all of the other sub-systems and interfaces remain. This avoids costly replacement of speed sensing, speed unit enforcement, aspect display, audible indicator, alarm units, power/brake interface relays, isolated power supply as well as the other sub-systems. It is important to recognize that these existing sub-systems and interfaces are Federal Railway Administration (FRA) approved and governed by FRA inspections, daily test and periodic test.

Similar arguments can be developed for the simplicity and cost savings benefits of retaining the existing wayside speed commands and/or aspects. For example, interface with existing CAB signal code selection network and/or wayside signal lighting circuits provide the new system with speed limit, train separation, and route interlocking data.

Trains equipped with the RAD CAB ATC system will be able to operate in both the existing rail-transmitted ATC areas and the RAD CAB—ATC (CBTC) areas. Trains so equipped will be able to easily and readily transition from one ATC system to another.

The proposed RAD CAB ATC system also allows a smooth upgrade from the old rail-transmitted ATC system to the new RAD Cab ATC operating system in those areas that presently have ATC. For example, existing rail-transmitted ATC territory will accept old or new car equipment. An upgraded wayside zone with RAD Cab ATC car equipment will provide a more efficient operation due to the advantages of CBTC.

Additionally, because the RAD CAB ATC system is based on a digital radio link and a GPS link it can be used to signal or extend signaling into dark territory.

Still further objects and advantages will become apparent from a consideration of the ensuing description and drawings.

### DRAWING FIGURES

Sheet 1 illustrates the additional of RAD CAB to existing carborne ATC systems.

Sheet 2 illustrates the implementation of RAD CAB with an existing wayside ATC system.

Sheet 3 illustrates a RAD CAB equipped train following a RAD CAB equipped train.

Sheet 4 illustrates an existing ATC equipped train following a RAD CAB equipped train.

Sheet 5 illustrates a RAD CAB equipped train following an existing ATC equipped train.

Sheet 6 illustrates a typical braking time chart.

Sheet 7 illustrates a RAD CAD equipped highway crossing interacting with a RAD CAB equipped train.

Sheet 8 illustrates a RAD CAB equipped quad gate highway crossing interacting with a RAD CAB equipped train.

### REFERENCE DISCRIPTIONS IN DRAWINGS

“Existing Wayside ATC Systems” may be any approved and recognized method of safely enforcing train movements based on transponders, track circuits, or wheel detectors.

“Train Locations Systems” may be any method of identifying position of train on tracks including but no limited to Global Position Systems (GPS), transponders, wiggley wire, optical reflectors and dead reckoning.

### DESCRIPTION—PREFFERED EMBODIMENT

The illustration on sheet 1 depicts the scope of installation required to upgrade existing carborne ATC with RAD CAB. A GPS antenna input is used in this example for location data input. A Data Radio antenna & receiver is installed. All outputs of the RAD CAB are vital. A vital digital output is installed to toggle the existing track receiver to RAD CAB coded carrier output through a vital relay (XFER). An optional bypass switch may be installed on the digital output to prevent the RAD CAB unit from seizing the coded carrier inputs to the carborne ATC if desired. The optional bypass switch would open circuit the control wiring to the vital XFER relay causing it to drop, transferring the carborne ATC track receiver inputs back to the car mounted track receivers.

Upon initial power up of the RAD CAB unit, the vital processor will establish an operational mode. Once the processor is operational it will examine the status of train location (GPS, etc) input data and Data Radio input data.

Once the RAD CAB unit has determined the location coordinates to be valid and appropriate, the data radio will begin to transmit to establish contract with central control. Central will identify the RAD CAB unit via a unique address assigned to each unit. Once central control identifies the newly activated RAD CAB unit, given its location and speed, central will instruct RAD CAB to energize the vital XFER relay and toggle the track receiver inputs to the coded carrier output. At this point the existing cab signal sub-system is receiving all commands from the RAD CAB system and will continue to receive commands until RAD CAB deactivates the vital XFER relay. The RAD CAB system must be vital and every link in the RAD CAB signal path must be vital in implementation.

The illustration on Sheet 2 shows the interconnection of RAD CAB hardware to existing wayside signal and control hardware. RAD CAB hardware interfaces with each interlockings' CAB signal/train detection and signal control sub-system on a local level. Local level equipment will have a two-way data radio link. The interface of the local RAD CAB interface is minimal in scope, essentially mirroring the existing speed limit, train separation and route data. The central RAD system will interface to the Central Control office accessing the network of interlocking under Central Control. The central RAD system also has a two-way data radio for communication with cab and local units.

Moving from RAD CAB Controlled Territory to Coded Track (Cab Signal territory.

As a RAD CAB unit leaves RAD CAB controlled territory entering coded track control, the RAD CAB would reactivate the car mounted track receivers and the ATC package would read coded track signals. The transition points could be related to track occupancy detection of the train inside coded track territory. Once the train is detected to be inside of coded track territory the RAD CAB would be signaled from local/central RAD ATC system to revert control of the ATC track receiver to the carborne ATC system.

Moving from RAD CAB Controlled Territory to Coded Track Control Using Location Coordinates.

As a RAD CAB unit leaves RAD CAB controlled territory entering coded track control, the RAD CAB would reactivate the car mounted track receiver and the ATC package would read coded track signals. The transition point would be selected by the RAD CAB unit using location coordinates to affect the cut over.

RAD CAB Equipment Following RAD CAB Equipment (Sheet 3)

RAD CAB equipment following RAD CAB equipment would benefit from the constant stream of information on each other. The following train would have constant information on the front train speed & position and as a result would be able to maintain a safe braking distance yet follow much closer that permissible using existing track circuit technology. The implementation of Moving Block is possible using RAD CAD providing that all equipment in a given zone is actively using RAD CAB for ATC input.

Existing ATC Equiped Train Following RAD CAB Equipment (Sheet 4)

Leading RAD CAB equipment may have all the benefits of the RAD CAB system without any consideration of the equipment that may be behind it. Here the following train would still operate on existing coded track control.

RAD CAB Equipment Following Existing ATC Equiped Train (Sheet 5)

RAD CAB equipped train following an existing ATC train will be able to receive ATC commands form RAD CAB but safe braking distance would be dictated by track occupancy.

Failure Reactions

Use in High Interference/Critical Positioning Areas

The RAD CAB may occasionally experience imprecise location data due to GPS (or radio telemetry) which is unacceptable in stations/interchanges and yard areas. In such areas where precise train location is imperative, RAD CAB would be switched to the existing ATC system, which is based on track circuits, wheel detectors, etc.

RAD CAB is subject to interference form natural or man made barriers, either physical or electrical in nature, examples are: tunnels, high electrical noise environment, etc. In these locations RAD CAB would be switched out and the existing signal, cab signal or other proven train control system would be used. A suggested set up for a long tunnel would be to have the tunnel under ATC control via coded track circuits rather than trying to install transmitters for RAD CAB and providing a solution for loss of GPS signal. The train could automatically be switched from RAD CAB to a conventional coded track/wayside system upon approach to tunnel and automatically switched back at the other end of the tunnel.

Loss of Location Data Input (GPS or Other)

Loss of a valid location feedback signal beyond a preset threshold time (to be determined) would be sensed by the RAD CAB package and based on programming would revert control to track receivers (coded rail) ATC operation. It would be possible to do a limited amount of “dead reckoning” using speed input and to remain on RAD CAB control. Wayside feedback of position could be used to correct errors in dead reckoning calculations depending on severity of locations input equipment failure if planned for.

Loss of Data Radio

Loss of a valid Data Radio signal reception by RAD CAB beyond a preset threshold time (to be determined) would be sensed internally by the RAD CAB package and would revert control to track receivers (coded rail) ATC operation. In non-signaled or dark territory the ATC package would be cut out and the train would be operated per railroad rulebook.

Loss of Data Radio (Response from RAD CAB Only)

In the event of loss of a valid Data Radio signal reply from a RAD CAB package to wayside equipment certain wayside control such as uniformly timed advanced highway crossing warnings will not be available. Highway crossing would still operate but based on detection at fixed lengths from highway crossing and warning time would become a function of entering train speed. Other wayside features such as train identification may not be available. Any RAD CAB equipped train following such a failing train would immediately be instructed to reduce speed or stop via RAD CAB system and safe braking distance would be based on track occupancy of the failing train. See RAD CAB following ATC CAB described previously. Any train preceding a failing train would continue normal operation. Recovery of data radio communication from a failing train would allow all to resume normal operations.

It is the purpose of this design to build an ATC system that would systematically revert control from RAD CAB to ATC CAB with or without intermediate wayside signals. The RAD system recommends maintaining existing interlocking and automatic block circuits to main the absolute train protection that they provide.

Loss of RAD CAB Inputs to ATC

Any loss of inputs to the cab signal sub-system from RAD CAB would be treated as a loss of code by the carborne ATC. The operator could bypass the RADCAB track receiver XFER control in an attempt to read track code, assuming that RAD CAB had a failure that did not toggle the track receivers on.

The vital processor design of RAD CAB will ensure that loss of a data radio will cause a deactivation of RAD CAB and reactivation of track receivers via a vital relay. If the carborne ATC package does not receive a valid signal it will react to this as a no code event. ATC systems with ability to self-test track receiver may be set to test the integrity of the track receivers.

Optional Features

RAD CAB can support many optional features. The optional features may require modification to existing car or wayside equipment depending upon the nature of the added features.

The bi-directional (two way) Data Radio link offers a variety of options and features, including but not limited to: Validation of signals between car, wayside and central using a hand shake technique; train speed and location to highway crossing for efficient starts and restarts; status of crossing to train for slow downs or stops; status of home signal for positive stop and release; transmission of train number/ID for auto routing, station announcements and/or maintenance log; recording of key car/wayside function for legal as well as diagnostic purposes.

Reduced Braking Distances by Elemination of ATC Decoder Front End (Sheet 6)

Transit vehicles incorporate a time delay in the sensing of ATC commands to allow for transmission, reception and propagation time through the ATC system from wayside to cab package. The “reaction time” of a typical system is approximately 3 seconds. Using RAD CAB this model may be reduced depending on several factors. Reduction in the reaction time of the ATC system results in faster braking responses and shorter safe braking distances. The shorter safe braking distances translate into shorter headway and higher traffic. Additional reaction time saving may be possible by bypassing the decoder circuitry of the ATC system, using instead a direct digital input method, with either serial or parallel inputs.

This method would require loss of contact time out to be extremely small (Recognition time) and operability of the data radio system to be very high. Time allotted to recognition must be added to the Safe Braking Distance model.

RAD CAB signal recognition time=

Radio Signal Recognition time

Plus RAD CAB processing and verification time

Plus ATC recognition time (much smaller than required for coded signal decoder front end)

Plus Maximum error in location device (GPS)

Cab Signal recognition time=

Time to shunt rail

Plus time for wayside to transmit rail code

Plus reception/filter/processes time for Cab Signal package

Plus reaction time of Cab Signal processor.

Highway Crossing Constant Warning System (Sheet 7)

The communications based train control system would be able to transmit approach speed and location to the wayside controls. This information would then be used to time the activation of crossing lights, audible warnings and barriers to a consistent time interval despite slower approach speeds. In the event of a failure of RAD CAB equipment, no car speed response would be available to wayside control equipment. The wayside equipment would revert to area warning with activation time varying with respect to approach speed.

Quad Gate Crossing Protection (Sheet 8)

The Federal Railway Administration (FRA) recommends quad gate crossings be designed with vehicle occupancy detectors to identify any vehicles inside the gate-protected area. With RAD CAB, approaching trains could be alerted, slowed and stopped before striking the trapped vehicle. Visual images of highway crossing could be transmitted to the RAD CAB equipped train. Image recognition can discover obstacles that cannot be detected with proximity loops.

Station Stops in Approach Area of the Crossing

Train station stops that are in close proximity to highway crossings may be better served by RAD CAB technology. Trains approaching a stop before a highway crossing would not need to activate the highway crossing unduly since the RAD CAB and the local RAD ATC system could closely monitor the speed of an approaching train and ensure that it was braking consistent with stopping before the highway crossing. Initialization of such a crossing warning from a stopped train may be based on detected motion or throttle position changes. This RAD system approach is an improvement on current predictor techniques base on radio cab feedback.

Operator Activated Crossing Protection

Operator inputs can be used for restarting crossings in close proximity to station stops. For locations where the proximity of the station stop is too close to a highway crossing to permit timely detection of departing trains, an additional RAD CAB input could be provided. The operator, prior to departure, would manually activate this input to initiate the crossing protection device via RAD CAB.

Wayside Equipment Status Monitoring

Highway crossings that are activated by RAD CAB, with a back up system based on track occupancy, should be assigned to verify the operation of the back up system each time the equipment is activated by RAD CAB. Two-way data radio communication could be used to send status messages of wayside equipment back to central. This is to ensure the viability of the back up system and to assist maintainers in preventing future mis-operation. Coupling the reported data with a recorder for logging RAD CAB responses may satisfy some requirements for periodic testing of wayside equipment.

Safe Braking Distance for Mixed Fleet Systems Could be Fleet Specific The shorter safe braking distance achievable by the RAD CAB equipped car fleet could be applied to raise speed limits, reduce run time and headway if desired. Safe braking distance margins could be selectively/automatically modified based on weather, time or other events and immediately implemented via RAD CAB control. For example, during adverse adhesion conditions such as frost, track speed could be speed restricted until three consists pass over the track, them speed restriction would be lifted.

Positive Stop

RAD CAB provides the ability to increase ATC functionality without requiring additional trackside hardware (additional code generators or transponders). Only the carborne ATC package and RAD CAB would need to be updated/reconfigured for additional functionality. Positive Stop enforcement is desirable at Home (absolute stop signals). With RAD CAB this function can be enforced including a positive radio release.

Cross Check of Speed/Onboard Settings

Train speed may be cross checked via a GPS computed speed. ATC inputs such as wheel size could be monitored and cross checked by RAD CAB using GPS. Improper wheel size settings in the ATC carborne package could be flagged and messages sent to central command notifying maintenance of a potential incorrect setting.

Train Identification to Wayside

Trains may be identified to wayside in advance of approach vial RAD CAB. This information combined with station/wayside information may be used to announce arriving trains and calculate time to arrival. Train identification may also be used for automatic routing. Train identification coupled with onboard diagnostic monitoring may also be used to determine auto routing on approach to yard/service areas on a need basis.

Additional GPS Triggered Functions

Transponder systems could be partially or completely replaced by RAD CAB. Carborne sub-systems currently triggered by track/wayside mounted transponders could be triggered by GPS systems. Furthermore, RAD CAB could transmit data to the subsystem to indicate selective responses to such trigger points. This includes functions such as automatic station stop initiation and re-referenced points, grade and curve reference points; temporary speed limits in work zones and other similar functions.

Integration of Multiple Systems on a Given Railway

RAD CAB may be incrementally installed and implemented on an operating railway. Migration to a moving block system is also possible incrementally as onboard equipment is upgraded. Once the majority of units have been converted, moving block signaling could be phased into operations. This presents a logical evolution to a CBTC system.

RAD CAB can also support a multitude of different options and enhancements beyond traditional ATC commands. An important feature of the RAD CAB design is the ability to interface with existing ATC system quickly with minimal disturbance to carborne equipment yet retain all functionality while creating a redundant ATC system.

What we claim as our invention is:

1. A method for train control and signaling, said system comprising:
A radio signal;
A train location system;
An apparatus carried on-board that can receive the radio signals and train location data then output a coded carrier to carborne ATC equipment.

2. A method according to claim 1, wherein the on-board apparatus can disconnect the track receiver outputs and connect the apparatus output into carborne ATC equipment.

3. A method according to claim 2, wherein the disconnect and reconnect device is a vital relay.

4. An apparatus carried on-board that receives radio signals and a location signal and outputs a coded carrier.

5. The apparatus in claim 4 where said apparatus controls a switching device that would disconnect the track receiver outputs from the carborne ATC equipment and connect the apparatus coded carrier outputs to the carborne ATC equipment

6. The apparatus in claim 4 in which radio signals may also be sent.
